(19) United States
(12) Patent Application Publication
(10) Pub. No.: US 2026/0196555 A1
(43) Pub. Date: Jul. 9, 2026

(54) SULFIDE SOLID ELECTROLYTE MEMBRANE WITH DUAL BINDER SYSTEM

(71) Applicant: GM GLOBAL TECHNOLOGY OPERATIONS LLC, Detroit, MI (US)

(72) Inventors: Xin ZHANG, Shanghai (CN); Yong LU, Shanghai (CN); Zhe LI, Shanghai (CN); Haijing LIU, Shanghai (CN)

(21) Appl. No.: 19/439,202

(22) Filed: Jan. 2, 2026

(30) Foreign Application Priority Data
Jan. 7, 2025 (CN) 2025100280532

(51) Int. Cl. H01M 10/0562; H01M 50/414; H01M 50/431; H01M 50/446; H01M 50/491; H01M 50/497

(52) U.S. Cl. CPC H01M 10/0562; H01M 50/414; H01M 50/431; H01M 50/446; H01M 50/491; H01M 50/497; H01M 2300/0068

(57) ABSTRACT

A solid-state battery cell includes A anode electrodes including an anode active material layer arranged on one or both sides of an anode current collector, C cathode electrodes including a cathode active material layer arranged on one or both sides of a cathode current collector, and S separators arranged between adjacent ones of the A anode electrodes and the C cathode electrodes, where A, C, and S are integers greater than one. Each of the S separators includes a sulfide solid electrolyte membrane including sulfide electrolyte particles and a dual binder system including a first binder and a second binder. The first binder includes a first polymer having steric hindrance functional groups on a branched chain. The steric hindrance functional groups are selected from a group consisting of a phenyl, an ester group, or combinations thereof.

### CROSS-REFERENCE TO RELATED APPLICATIONS

This application claims the benefit of Chinese Patent Application No. 202510028053.2, filed on Jan. 7, 2025. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly battery cells including sulfide solid electrolyte separators with a dual binder system.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

A solid-state battery cell includes A anode electrodes including an anode active material layer and an anode current collector, C cathode electrodes including a cathode active material layer and a cathode current collector, and S separators arranged between adjacent ones of the A anode electrodes and the C cathode electrodes, where A, C, and S are integers greater than one. Each of the S separators includes a sulfide solid electrolyte membrane including sulfide electrolyte particles and a dual binder system including a first binder and a second binder.

In other features, the first binder includes a first polymer having steric hindrance functional groups on a branched chain, and the steric hindrance functional groups are selected from a group consisting of a phenyl, an ester group, or combinations thereof.

In other features, the first binder has a molecular weight in a range from 200k to 1 million grams per mole (g/mol). The first binder is selected from a group consisting of styrene-[ethylene-(ethylene-propylene)]-styrene (SEEPS), hydroxyl group-containing styrene-[ethylene-(ethylene-propylene)]-styrene (SEEPS-OH), ethylene-branched SEEPS, styrene ethylene butylene styrene (SEPS), ethylene-branched SEPS, ethylene-branched styrene-isoprene-styrene (SIS), styrene-butadiene-styrene (SBS), styrene ethylene butylene styrene (SEBS), and poly(butyl methacrylate).

In other features, the second binder includes a polymer having a glass transition temperature less than 0° C. The second binder has a molecular weight in a range from 200k to 1 million g/mol. The second binder is selected from a group consisting of poly(ethylene oxide) (PEO), nitrile butadiene rubber (NBR), polyvinylidene difluoride (PVDF), and hydrogenated acrylonitrile butadiene rubber (HNBR). The dual binder system includes the first binder in a range from 60 to 90 wt % and the second binder in a range from 10 to 40 wt %. The S separators include the sulfide electrolyte particles in a range from 80 to 97 wt % and the dual binder system in a range from 3 to 20 wt %.

In other features, the S separators have a thickness in a range from 10 μm to 300 μm. The S separators have a porosity prior to being condensed in a range from 3% to 50%. The sulfide electrolyte particles are selected from a group consisting of pseudobinary sulfide, pseudoternary sulfide, pseudoquaternary sulfide, a halide-based solid electrolyte, a hydride-based solid electrolyte, and combinations thereof.

A separator membrane for a solid-state battery cell includes sulfide solid electrolyte particles selected from a group consisting of pseudobinary sulfide, pseudoternary sulfide, pseudoquaternary sulfide, a halide-based solid electrolyte, a hydride-based solid electrolyte, and combinations thereof. A dual binder system includes a first binder and a second binder. The separator membrane comprises the sulfide solid electrolyte particles in a range from 80 to 97 wt % and the dual binder system in a range from 3 to 20 wt %. The first binder includes a first polymer having high steric hindrance functional groups selected from a group consisting of a phenyl, an ester group, or combinations thereof. The first binder has a molecular weight in a range from 200k to 1 million grams per mole (g/mol). The second binder includes a second polymer having a glass transition temperature less than 0° C. and a molecular weight in a range from 200k to 1 million g/mol.

In other features, the first binder is selected from a group consisting of styrene-[ethylene-(ethylene-propylene)]-styrene (SEEPS), hydroxyl group-containing styrene-[ethylene-(ethylene-propylene)]-styrene (SEEPS-OH), ethylene-branched SEEPS, styrene ethylene butylene styrene (SEPS), ethylene-branched SEPS, ethylene-branched styrene-isoprene-styrene (SIS), styrene-butadiene-styrene (SBS), styrene ethylene butylene styrene (SEBS), and poly(butyl methacrylate). The second binder is selected from a group consisting of poly(ethylene oxide) (PEO), nitrile butadiene rubber (NBR), polyvinylidene difluoride (PVDF), and hydrogenated acrylonitrile butadiene rubber (HNBR).

In other features, the dual binder system includes the first binder in a range from 60 to 90 wt % and the second binder in a range from 10 to 40 wt %. The separator membrane includes the sulfide solid electrolyte particles in a range from 80 to 97 wt % and the dual binder system in a range from 3 to 20 wt %. The separator membrane has a thickness in a range from 10 μm to 300 μm. The separator membrane has a porosity prior to being condensed in a range from 3% to 50%.

A method for manufacturing a separator membrane for a solid-state battery cell includes mixing a first solution including a first binder including a polymer having a high steric hindrance and a molecular weight in a range from 200k to 1 million grams per mole (g/mol); mixing a second solution including a second binder including a polymer having a glass transition temperature less than 0° C. and a molecular weight in a range from 200k to 1 million g/mol; mixing sulfide solid electrolyte particles, the first solution and the second solution to form a slurry, wherein the sulfide solid electrolyte particles are selected from a group consisting of is selected from a group consisting of pseudobinary sulfide, pseudoternary sulfide, pseudoquaternary sulfide, a halide-based solid electrolyte, a hydride-based solid electrolyte, and combinations thereof; and coating the slurry onto a surface to form a separator membrane layer having a thickness in a range from 10 to 300 μm; and drying the separator membrane layer.

In other features, the first binder is selected from a group consisting of styrene-[ethylene-(ethylene-propylene)]-styrene (SEEPS), hydroxyl group-containing styrene-[ethylene-(ethylene-propylene)]-styrene (SEEPS-OH), ethylene-branched SEEPS, styrene ethylene butylene styrene (SEPS), ethylene-branched SEPS, ethylene-branched styrene-isoprene-styrene (SIS), styrene-butadiene-styrene (SBS), styrene ethylene butylene styrene (SEBS), and poly(butyl methacrylate). The second binder is selected from a group consisting of poly(ethylene oxide) (PEO), nitrile butadiene rubber (NBR), polyvinylidene difluoride (PVDF), and hydrogenated acrylonitrile butadiene rubber (HNBR).

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of a solid-state battery cell including a sulfide solid electrolyte membrane according to the present disclosure;

FIG. 2 is an enlarged side cross section of a sulfide solid electrolyte membrane including a dual binder system according to the present disclosure;

FIGS. 3A to 3I illustrate examples of a first binder of the dual binder system according to the present disclosure;

FIGS. 4A to 4D illustrate examples of a second binder of the dual binder system according to the present disclosure; and

FIG. 5 is a flowchart of a method for manufacturing the solid electrolyte membrane with the dual binder system according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

For solid-state battery cells, a solid electrolyte membrane may be used as a separator to separate cathode electrodes and anode electrodes. Sulfide solid electrolyte membranes are used for batteries due to high lithium ion conductivity, a wide operating temperature range, and/or abuse tolerance. Formation of sulfide solid electrolyte membranes is important for large-scale manufacturing of solid-state battery cells.

Formation of the sulfide solid electrolyte membranes rely upon bonding of sulfide solid electrolyte particles using a binder. Various binders have been used to bond the sulfide solid electrolyte particles. However, it has been difficult to manufacture sulfide solid electrolyte membranes with both high strength and high flexibility. Sulfide solid electrolyte membranes that are flexible are usually fragile, which makes handling during manufacturing difficult. Solid electrolyte membranes that have high strength are also usually brittle, which makes folding during assembly difficult.

The present disclosure relates to a sulfide solid electrolyte membrane including sulfide solid electrolyte particles and a dual binder system that has improved strength and flexibility. The dual binder system includes a first binder and a second binder.

The first binder includes block co-polymers or mono polymers having high steric hindrance functional groups on a branched chain. These functional groups can include phenyl, an ester group (-COOR, where R represents a C₃ to C₁₀ alkyl group), or a combination thereof.

The second binder includes co-polymers or mono polymers having a low glass transition temperature T_{g}. In some examples, the glass transition temperature T_{g} is less than 0° C. In some examples, the polymer of the second binder has a molecular weight in a range from 200k to 1 million grams per mole (g/mol). In some examples, the second binder is selected from a group consisting of poly(ethylene oxide) (PEO), nitrile butadiene rubber (NBR), polyvinylidene difluoride (PVDF), and hydrogenated acrylonitrile butadiene rubber (HNBR).

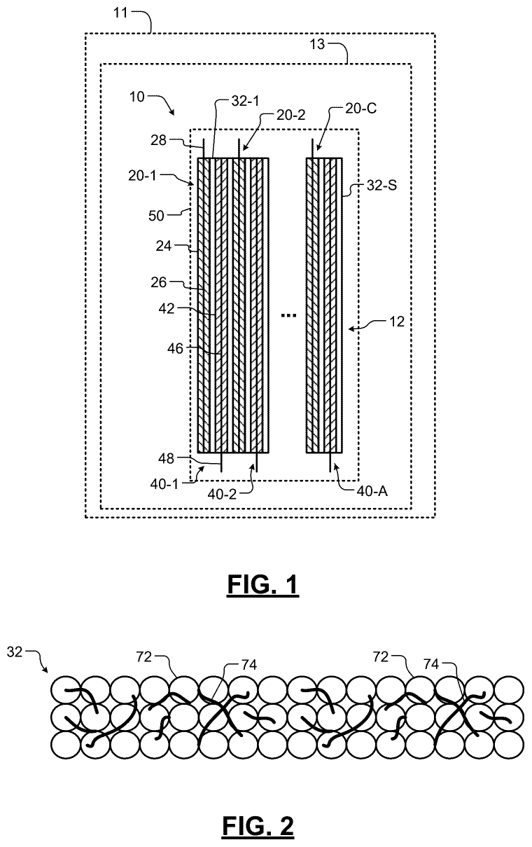

Referring now to FIG. 1, a solid-state battery cell 10 includes C cathode electrodes 20, A anode electrodes 40, and S separators 32 arranged in a predetermined sequence in a battery cell stack 12, where C, S and A are integers greater than zero. In some examples, the vehicle 11 includes a battery module or pack 13 including the solid-state battery cell 10. The battery cell stack 12 is arranged in an enclosure 50. The C cathode electrodes 20-1, 20-2, . . . , and 20-C include a cathode active material layer 24 on one or both sides of a cathode current collector 26. The A anode electrodes 40-1, 40-2, . . . , and 40-A include an anode active material layer 42 arranged one or both sides of an anode current collector 46.

During charging/discharging, the A anode electrodes 40 and the C cathode electrodes 20 exchange lithium ions. In some examples, the cathode active material layers 24 and/or anode active material layers 42 comprise coatings including one or more active materials, solid electrolyte, one or more conductive additives, and/or one or more binder materials that are applied to the current collectors.

In some examples, the anode current collectors 46 and/or the cathode current collectors 26 comprise metal foil, metal mesh, perforated metal, 3 dimensional (3D) metal foam, and/or expanded metal. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

Referring now to FIG. 2, one of the S separators 32 is shown to include sulfide solid electrolyte particles 72 and a dual binder system 74 including a first binder and a second binder. The first binder includes block co-polymers or mono polymers having high steric hindrance functional groups on a branched chain. These functional groups can include phenyl, an ester group (—COOR, R represent C₃ to C₁₀ alkyl group), or combinations thereof. The second binder includes co-polymers or mono polymers having a glass transition temperature T_{g} that is less than 0° C.

In some examples, the polymer of the first binder has a molecular weight in a range from 200,000 (200k) to 1 million grams per mole (g/mol). In some examples, the polymer of the first binder has a molecular weight in a range from 300k to 500k g/mol.

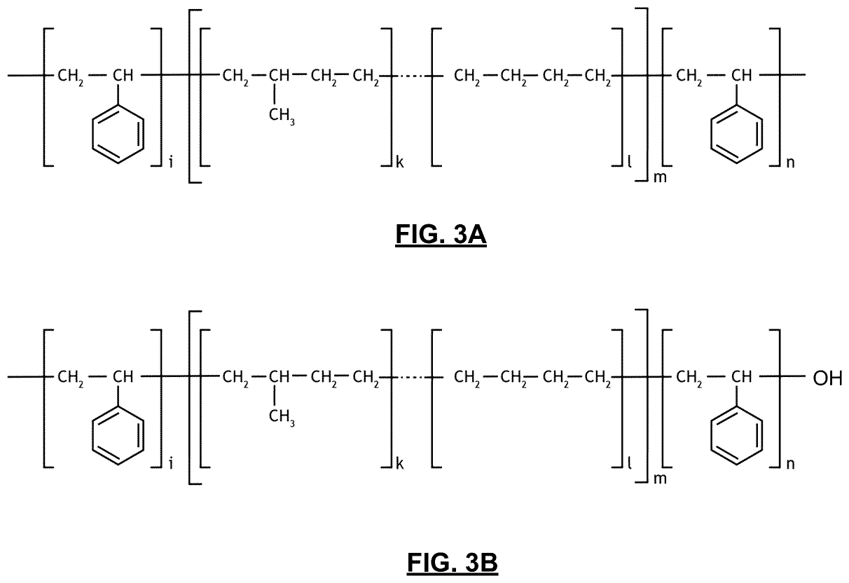

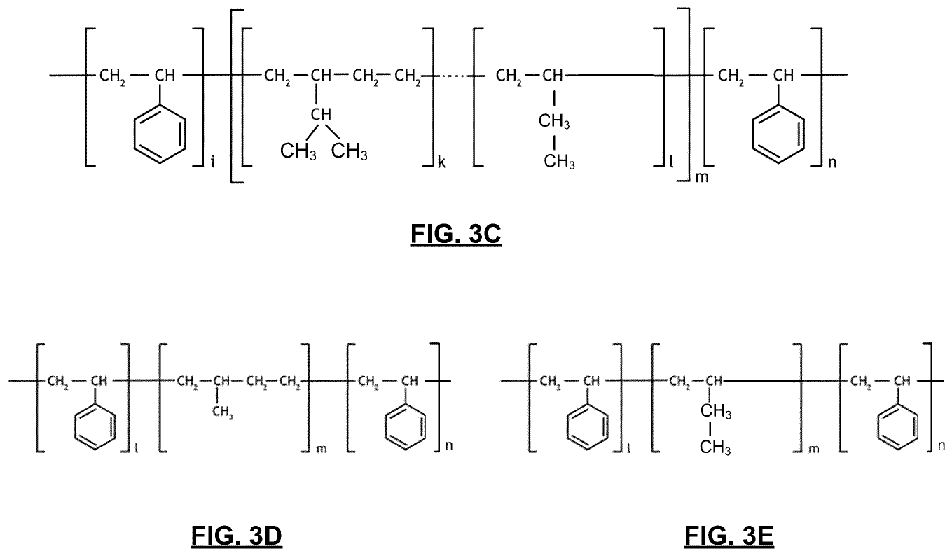

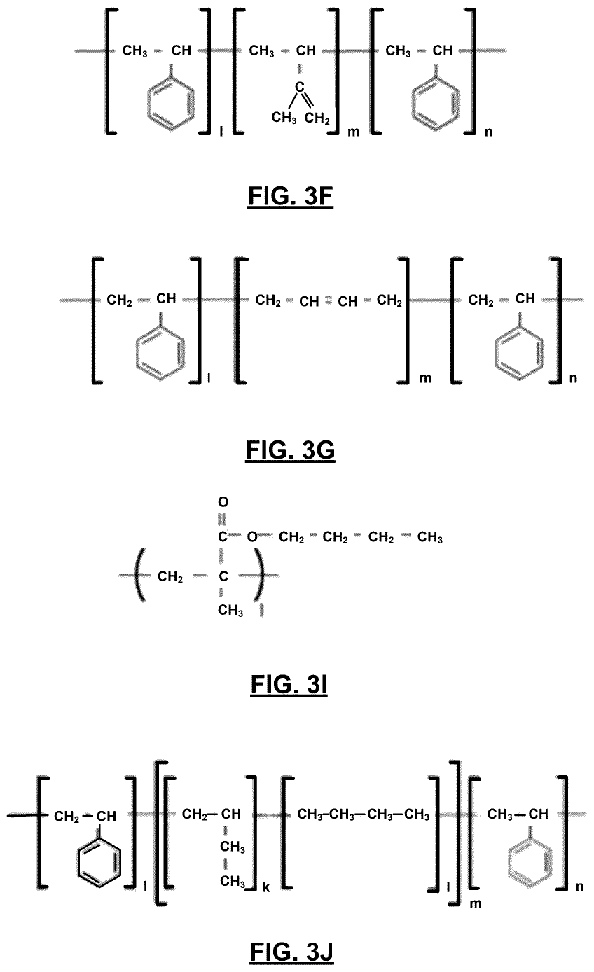

Referring now to FIGS. 3A to 3I, examples of the first binder are shown. In some examples, the first binder is selected from a group consisting of styrene-[ethylene-(ethylene-propylene)]-styrene (SEEPS) (see FIG. 3A), hydroxyl group-containing styrene-[ethylene-(ethylene-propylene)]-styrene (SEEPS-OH) (see FIG. 3B), ethylene-branched SEEPS (see FIG. 3C), styrene ethylene butylene styrene (SEPS) (see FIG. 3D), ethylene-branched SEPS (see FIG. 3E), ethylene-branched styrene-isoprene-styrene (SIS) (see FIG. 3F), styrene-butadiene-styrene (SBS) (see FIG. 3G), styrene ethylene butylene styrene (SEBS) (see FIG. 3H), and poly(butyl methacrylate) (see FIG. 3I).

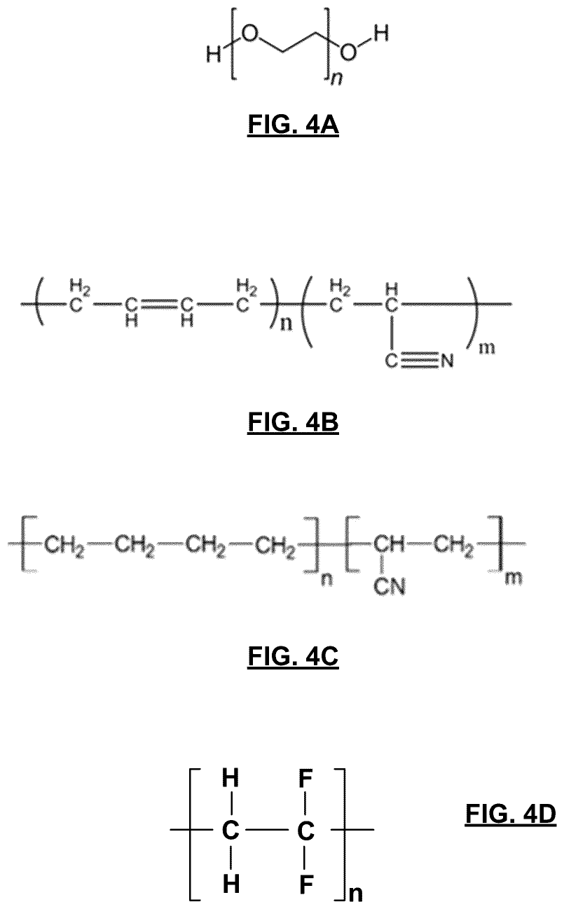

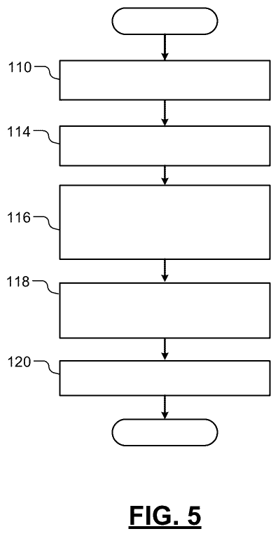

The second binder includes co-polymers or mono polymers having high a low glass transition temperature. In some examples, the glass transition temperature T_{g} is less than 0° C. In some examples, the polymer of the second binder has a molecular weight in a range from 200k to 1 million g/mol. In some examples, the polymer of the second binder has a molecular weight in a range from 300k to 500k g/mol. In some examples, the second binder is selected from a group consisting of poly(ethylene oxide) (PEO) (FIG. 4A), nitrile butadiene rubber (NBR) (FIG. 4B), hydrogenated acrylonitrile butadiene rubber (HNBR) (FIG. 4C), and polyvinylidene difluoride (PDVF) (FIG. 4d).

In some examples, the dual binder system includes the first binder in a range from 60 to 90 wt % and the second binder in a range from 10 to 40 wt %.

The S separators 32 include the solid electrolyte in a range from 80 to 97 wt %, and the dual binder system in a range from 3 to 20 wt %. In some examples, the solid electrolyte particles comprising greater than 90 wt % and the dual binder system comprises less than 10%. In some examples, the separator 32 has a thickness in a range from 10 μm to 300 μm. In some examples, the separator 32 has a thickness in a range from 10 μm to 50 μm. In some examples, the separator 32 has a porosity (prior to being condensed) in a range from 3% to 50%. In some examples, the separator 32 has a porosity less than 20%.

In some examples, the sulfide solid electrolyte particles are selected from a group consisting of pseudobinary sulfide, pseudoternary sulfide, pseudoquaternary sulfide, a halide-based solid electrolyte, a hydride-based solid electrolyte, or other solid electrolyte with high grain-boundary resistance, and combinations thereof.

Examples of pseudobinary sulfide include Li₂S-P₂S₅ system (Li₃PS₄, Li₇P₃S₁₁ and Li_{9.6}P₃S₁₂), Li₂S-SnS₂ system (Li₄SnS₄), Li₂S-SiS₂ system, Li₂S-GeS₂ system, Li₂S-B₂S₃ system, Li₂S-Ga₂S₃ system, Li₂S-P₂S₃ system, and Li₂S-Al₂S₃ system.

Examples of pseudoternary sulfide include Li₂O-Li₂S-P₂S₅ system, Li₂S-P₂S₅-P₂O₅ system, Li₂S-P₂S₅-GeS₂ system, (Li_{3.25}Ge_{0.25}P_{0.75}S₄ and Li₁₀GeP₂S₁₂), Li₂S-P₂S₅-LiX system (where X=F, Cl, Br, I), (Li₆PS₅Br, Li₆PS₅Cl, L₇P₂S₈I and Li₄PS₄I), Li₂S-As₂S₅-SnS₂ system, (Li_{3.833}Sn_{0.833}As_{0.166}S₄) system, Li₂S-P₂S₅-Al₂S₃ system, Li₂S-LiX-SiS₂ system (where X=F, Cl, Br, I), 0.4LiI-0.6Li₄SnS₄, and Li₁₁Si₂PS₁₂. Examples of pseudoquaternary sulfide include Li₂O-Li₂S-P₂S₅-P₂O₅ system, Li_{9.54}Si_{1.74}P_{1.44}S_{11.7}Cl_{0.3}, Li₇P_{2.9}Mn_{0.1}S_{10.7}I_{0.3} and Li_{10.35}[Sn_{0.27}Si_{1.08}]P_{1.65}S₁₂.

Examples of the halide-based sulfide electrolyte include Li₃YCl₆, Li₃InCl₆, Li₃YBr₆, Lil, Li₂CdCl₄, Li₂MgCl₄, Li₂Cd₁₄, Li₂Zn₁₄, and Li₃OCI. Examples of the hydride-based sulfide electrolyte include LiBH₄, LiBH₄-LiX (X=Cl, Br, or I), LiNH₂, Li₂NH, LiBH₄-LiNH₂, and Li₃AlH₆.

Referring now to FIG. 5, a method for manufacturing a sulfide solid electrolyte membrane is shown. At 110, a first binder is mixed with a solution. At 114, a second binder is mixed with a solution. At 116, the first binder solution, the second binder solution, and sulfide solid electrolyte particles are mixed and stirred to form a slurry. At 118, the slurry is coated onto a surface with a uniform thickness and the separator membrane is dried at 120 to form a separator membrane. In some examples, the slurry is spread using a doctor-blade.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is

1. A solid-state battery cell comprising:
A anode electrodes including an anode active material layer arranged on one or both sides of an anode current collector;
C cathode electrodes including a cathode active material layer arranged on one or both sides of a cathode current collector; and
S separators arranged between adjacent ones of the A anode electrodes and the C cathode electrodes, where A, C, and S are integers greater than one,
wherein each of the S separators includes a sulfide solid electrolyte membrane including sulfide electrolyte particles and a dual binder system including a first binder and a second binder.

2. The solid-state battery cell of claim 1, wherein:
the first binder includes a first polymer having steric hindrance functional groups on a branched chain, and
the steric hindrance functional groups are selected from a group consisting of a phenyl, an ester group, or combinations thereof.

3. The solid-state battery cell of claim 1, wherein the first binder has a molecular weight in a range from 200k to 1 million grams per mole (g/mol).

4. The solid-state battery cell of claim 1, wherein the first binder is selected from a group consisting of styrene-[ethylene-(ethylene-propylene)]-styrene (SEEPS), hydroxyl group-containing styrene-[ethylene-(ethylene-propylene)]-styrene (SEEPS-OH), ethylene-branched SEEPS, styrene ethylene butylene styrene (SEPS), ethylene-branched SEPS, ethylene-branched styrene-isoprene-styrene (SIS), styrene-butadiene-styrene (SBS), styrene ethylene butylene styrene (SEBS), and poly(butyl methacrylate).

5. The solid-state battery cell of claim 1, wherein the second binder includes a polymer having a glass transition temperature less than 0° C.

6. The solid-state battery cell of claim 1, wherein the second binder has a molecular weight in a range from 200k to 1 million g/mol.

7. The solid-state battery cell of claim 1, wherein the second binder is selected from a group consisting of poly(ethylene oxide) (PEO), nitrile butadiene rubber (NBR), polyvinylidene difluoride (PVDF), and hydrogenated acrylonitrile butadiene rubber (HNBR).

8. The solid-state battery cell of claim 1, wherein the dual binder system includes the first binder in a range from 60 to 90 wt % and the second binder in a range from 10 to 40 wt %.

9. The solid-state battery cell of claim 1, wherein the S separators include the sulfide electrolyte particles in a range from 80 to 97 wt % and the dual binder system in a range from 3 to 20 wt %.

10. The solid-state battery cell of claim 1, wherein the S separators have a thickness in a range from 10 μm to 300 μm.

11. The solid-state battery cell of claim 1, wherein the S separators have a porosity prior to being condensed in a range from 3% to 50%.

12. The solid-state battery cell of claim 1, wherein the sulfide electrolyte particles are selected from a group consisting of pseudobinary sulfide, pseudoternary sulfide, pseudoquaternary sulfide, a halide-based solid electrolyte, a hydride-based solid electrolyte, and combinations thereof.

13. A separator membrane for a solid-state battery cell comprising:
sulfide solid electrolyte particles selected from a group consisting of pseudobinary sulfide, pseudoternary sulfide, pseudoquaternary sulfide, a halide-based solid electrolyte, a hydride-based solid electrolyte, and combinations thereof; and
a dual binder system including a first binder and a second binder,
wherein the separator membrane comprises the sulfide solid electrolyte particles in a range from 80 to 97 wt % and the dual binder system in a range from 3 to 20 wt %,
wherein the first binder includes a first polymer having high steric hindrance functional groups selected from a group consisting of a phenyl, an ester group, or combinations thereof,
wherein the first binder has a molecular weight in a range from 200k to 1 million grams per mole (g/mol), and
wherein the second binder includes a second polymer having a glass transition temperature less than 0° C. and a molecular weight in a range from 200k to 1 million g/mol.

14. The separator membrane of claim 13, wherein:
the first binder is selected from a group consisting of styrene-[ethylene-(ethylene-propylene)]-styrene (SEEPS), hydroxyl group-containing styrene-[ethylene-(ethylene-propylene)]-styrene (SEEPS-OH), ethylene-branched SEEPS, styrene ethylene butylene styrene (SEPS), ethylene-branched SEPS, ethylene-branched styrene-isoprene-styrene (SIS), styrene-butadiene-styrene (SBS), styrene ethylene butylene styrene (SEBS), and poly(butyl methacrylate); and
the second binder is selected from a group consisting of poly(ethylene oxide) (PEO), nitrile butadiene rubber (NBR), polyvinylidene difluoride (PVDF), and hydrogenated acrylonitrile butadiene rubber (HNBR).

15. The separator membrane of claim 13, wherein the dual binder system includes the first binder in a range from 60 to 90 wt % and the second binder in a range from 10 to 40 wt %.

16. The separator membrane of claim 13, wherein the separator membrane includes the sulfide solid electrolyte particles in a range from 80 to 97 wt % and the dual binder system in a range from 3 to 20 wt %.

17. The separator membrane of claim 13, wherein the separator membrane has a thickness in a range from 10 μm to 300 μm.

18. The separator membrane of claim 13, wherein the separator membrane has a porosity prior to being condensed in a range from 3% to 50%.

19. A method for manufacturing a separator membrane for a solid-state battery cell comprising:
mixing a first solution including a first binder including a polymer having a high steric hindrance and a molecular weight in a range from 200k to 1 million grams per mole (g/mol);
mixing a second solution including a second binder including a polymer having a glass transition temperature less than 0° C. and a molecular weight in a range from 200k to 1 million g/mol;
mixing sulfide solid electrolyte particles, the first solution and the second solution to form a slurry, wherein the sulfide solid electrolyte particles are selected from a group consisting of is selected from a group consisting of pseudobinary sulfide, pseudoternary sulfide, pseudoquaternary sulfide, a halide-based solid electrolyte, a hydride-based solid electrolyte, and combinations thereof;
coating the slurry onto a surface to form a separator membrane layer having a thickness in a range from 10 to 300 μm; and
drying the separator membrane layer.

20. The method of claim 19, wherein:
the first binder is selected from a group consisting of styrene-[ethylene-(ethylene-propylene)]-styrene (SEEPS), hydroxyl group-containing styrene-[ethylene-(ethylene-propylene)]-styrene (SEEPS-OH), ethylene-branched SEEPS, styrene ethylene butylene styrene (SEPS), ethylene-branched SEPS, ethylene-branched styrene-isoprene-styrene (SIS), styrene-butadiene-styrene (SBS), styrene ethylene butylene styrene (SEBS), and poly(butyl methacrylate), and
the second binder is selected from a group consisting of poly(ethylene oxide) (PEO), nitrile butadiene rubber (NBR), polyvinylidene difluoride (PVDF), and hydrogenated acrylonitrile butadiene rubber (HNBR).
